(19) United States
(12) Patent Application Publication
(10) Pub. No.: US 2008/0308080 A1
(43) Pub. Date: Dec. 18, 2008

(54) Exhaust Gas Recirculation Control System

(76) Inventor: Freeman Carter Gates, Bloomfield Hills, MI (US)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/764,567

(22) Filed: Jun. 18, 2007

(51) Int. Cl. F02B 47/08

(52) U.S. Cl. 123/568.21

(57) ABSTRACT

The control signal on the EGR valve is based on an indication of whether the engine will soon encounter a condition with insufficient vacuum in the engine intake to operate the EGR valve. When such condition is about to be encountered, the desire is to supply a vacuum on the EGR valve and to hold such vacuum so that the EGR valve remains open.

An EGR system is disclosed which has an electronic valve regulator (EVR) coupled to the EGR valve and an engine intake. A disk within the body of the EVR rises when voltage is applied to the coil in the EVR causing intake vacuum to be communicated to the EGR valve. A stop within the EVR allows the disk to seal when voltage is applied, thereby allowing the engine intake vacuum to be maintained. The stop is in the shape of a ring within the EVR.

### TECHNICAL FIELD

This invention relates generally to internal combustion engines and more particularly to internal combustion engines having exhaust gas recirculation (EGR) systems.

### BACKGROUND OF THE INVENTION

As is known in the art, new 5-cycle EPA fuel economy tests are designed to replicate real world customer driving patterns. The new highway FE (fuel economy) label will be influenced greatly by US06 level testing (80%). During these tests, the acceleration rates are greater than or equal to 15 mph/sec. The existing FTP (Federal Test Procedure) requirements are approximately 3 mph/sec. Under these rapid acceleration conditions, the inventors have recognized that with some vehicles the vacuum in the intake is insufficient to open the EGR valve since the throttle is at or near wide open throttle conditions. Furthermore, if the EGR valve is actuated to open, the vacuum in the electronic valve regulator, which controls the vacuum applied to the EGR valve, leaks down. Thus, even when the EGR valve is caused to open, it closes too quickly by virtue of the vacuum leaking down.

### SUMMARY OF THE INVENTION

The EGR system includes an EGR valve for controlling exhaust gas flow between an exhaust manifold of the engine and an intake manifold of the engine and an EGR control system for producing a control signal for the EGR valve. The control signal is based on an indication of whether the engine will soon encounter a condition with insufficient vacuum in the engine intake to operate the EGR valve. When such condition is about to be encountered, the desire is to supply a vacuum on the EGR valve and to hold such vacuum so that the EGR valve remains open.

An EGR system is disclosed which has an EVR (electronic valve regulator) coupled to the EGR valve and an engine intake. A coil and stator are disposed in the electronic valve regulator with a disk within the body of the EVR, which is attracted to rise when a DC voltage is applied to the coil. This causes engine intake vacuum to be communicated to the EGR valve. A stop within the body of the EVR causes the disk to seal when the disk is actuated toward said stator allowing the engine intake vacuum to be maintained on the lower portion of the disk without leaking to atmospheric on the upper side of the disk. The stop is in the shape of a ring within the EVR.

The disk is coupled to a spring which pulls the disk away from the stator. The neutral position of the disk, when no DC voltage is applied, is for the disk to be away from the stop, i.e., with no seal formed. When a DC voltage is applied to the coil, the stator acts upon the disk causing the disk to abut against the stop. When the disk is at the stop, a seal is formed and manifold vacuum is communicated to the EGR valve.

An advantage of the stop is that it maintains a seal much better than without the disk. Thus, manifold vacuum can be trapped and communicated to the EGR valve to allow continued EGR flow when manifold vacuum is dropping.

The details of one or more embodiments of the invention are set forth in the accompanying drawings and the description below. Other features, objects, and advantages of the invention will be apparent from the description and drawings, and from the claims.

### BRIEF DESCRIPTION ON THE FIGURES

FIG. 1 is a diagram of an internal combustion engines having an EGR system according to the invention;

FIG. 2a-b show in detail the electronic valve regulator (EVR) with a 0% duty cycle and 100% duty cycle applied to the coil; and

FIG. 3 is a flow chart of the process used by the EGR control system in FIG. 1.

Like reference symbols in the various drawings indicate like elements.

### DETAILED DESCRIPTION

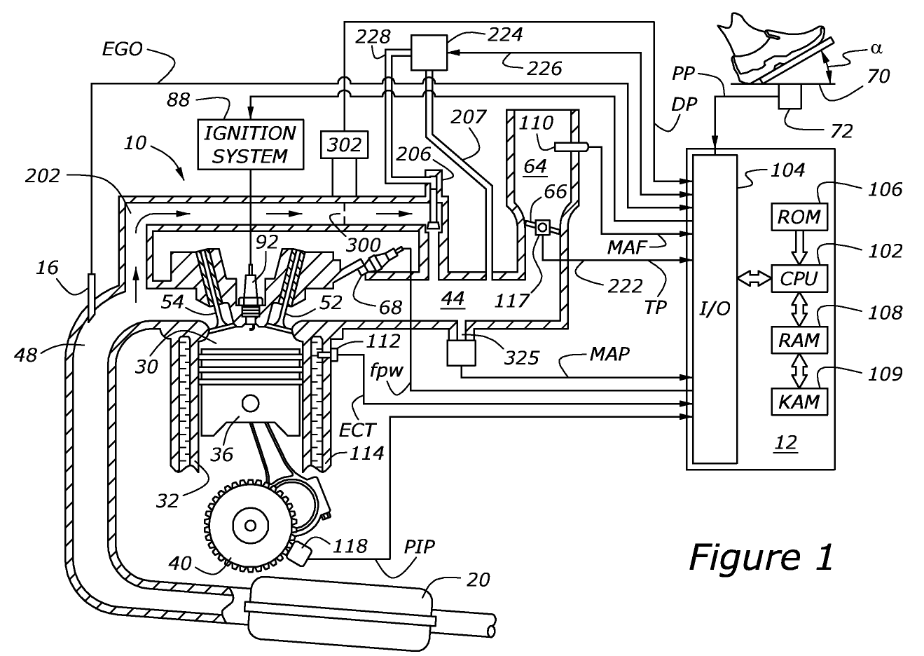

Referring now to FIG. 1, an internal combustion engine 10 is shown comprising a plurality of cylinders, one cylinder of which is shown in FIG. 1, controlled by electronic engine controller 12. Engine 10 includes combustion chamber 30 and cylinder walls 32 with piston 36 positioned therein and connected to crankshaft 40. Combustion chamber 30 communicates with intake manifold 44 and exhaust manifold 48 via respective intake valve 52 and exhaust valve 54. Exhaust gas oxygen sensor 16 is coupled to exhaust manifold 48 of engine 10 upstream of catalytic converter 20.

Intake manifold 44 communicates with throttle body 64 via throttle plate 66. Intake manifold 44 is also shown having fuel injector 68 coupled thereto for delivering fuel in proportion to the pulse width of signal (fpw) from controller 12. Fuel is delivered to fuel injector 68 by a conventional fuel system (not shown) including a fuel tank, fuel pump, and fuel rail (not shown). Engine 10 further includes a conventional distributorless ignition system 88 to provide ignition spark to combustion chamber 30 via spark plug 92 in response to controller 12. In the embodiment described herein, controller 12 is a conventional microcomputer including: microprocessor unit 102, input/output ports 104, read only memory (ROM) 106, random access memory (RAM) 108, and a conventional data bus. The controller 12 may also include keep alive memory (KAM) 109.

Controller 12 receives various signals from sensors coupled to engine 10, in addition to those signals previously discussed, including: measurements of inducted mass air flow (MAF) from mass air flow sensor 110 coupled to throttle body 64; engine coolant temperature (ECT) from temperature sensor 112 coupled to cooling jacket 114; a measurement of manifold pressure (MAP) from manifold pressure sensor 116 coupled to intake manifold 44; a measurement of throttle position (TP) from throttle position sensor 117 coupled to throttle plate 66; a measure of pedal position from pedal position sensor 72 coupled to accelerator pedal 70; and a profile ignition pickup signal (PIP) from Hall effect sensor 118 coupled to crankshaft 40.

Intake manifold 44 communicates with exhaust gas recirculation (EGR) valve assembly 206. Exhaust gas is delivered to intake manifold 44 by a conventional EGR tube 202 communicating with both EGR valve assembly 206 and electronic valve regulator (EVR) 224 from exhaust manifold 48. EVR 224 is coupled to EGR valve assembly 206 through a tube 228. EVR 224 receives vacuum from the intake manifold 44 through tube 207. Vacuum source 224 receives actuation signal (226) from controller 12.

A control orifice 300 is disposed in tube 202, as shown. The differential pressure across orifice 300 is sensed by a differential pressure sensor 302. The differential pressure signal DP is fed to controller 12, as shown.

Barometric pressure is detected by MAP sensor 116 at key on, i.e., before the engine has developed a vacuum in the intake manifold and can be updated during operation when wide open throttle operation has been achieved. Alternatively, a barometric pressure sensor (not shown), coupled to controller 12, is employed.

The signal on line 226 is a pulse width modulated signal with a duty cycle varied in accordance with the error signal (difference between desired pressure drop and actual pressure drop). A 100% duty cycle causes EVR 224 to be open and apply as much vacuum as is available in the manifold onto diaphragm 308. However, EVR 224 cannot open without sufficient vacuum. When such an operating condition is about to be encountered, i.e., insufficient vacuum to actuate the EGR valve, control switches from normal EGR control, varying in response to engine operating conditions, to fixed control. As described above according to one embodiment, EVR 224 is controlled by imposing a duty cycle. Fixed control corresponds to commanding 100% duty cycle. The EGR valve described herein is not intended to be limiting. Other types of EGR valve control are compatible with the present invention.

A sufficient vacuum is that which allows EGR valve actuation. Depending on the EGR valve design, a sufficient vacuum is in the range of 3 to 6 inches Hg. The vacuum is defined as a difference in pressure between intake 44 and barometric pressure.

The closed loop system that modulates a pneumatically-controlled EGR valve, according to one embodiment, is controlled so as to achieve a desired flow. This system infers actual flow based on a measure of the differential pressure drop across orifice 300 located in the EGR flow stream.

In an alternative embodiment, the desired flow can be achieved by mapping the opening position of the EGR valve to EGR flow. Closed loop control is based on a position sensor (typically potentiometric) mounted directly on top of the EGR valve providing a proportional resistance (or voltage) as an indicator of EGR valve position. Based on upstream (exhaust) pressure and downstream pressure (MAP) and EGR temperature EGR flow is computed. The error signal is the difference between the desired valve position (voltage) and the actual EVP (EGR valve position sensor) voltage. This error is fed into a PI or PID controller to achieve the desired EGR valve position.

A variety of engine operating parameters are suitable to indicate that an engine operating condition with insufficient vacuum is soon to be encountered by engine 10: throttle position, time rate of change of throttle position, pedal position, time rate of pedal position, MAP, a time rate of change of MAP, normalized engine torque (actual torque divided by maximum torque at the particular rpm), and rate of change of normalized engine torque.

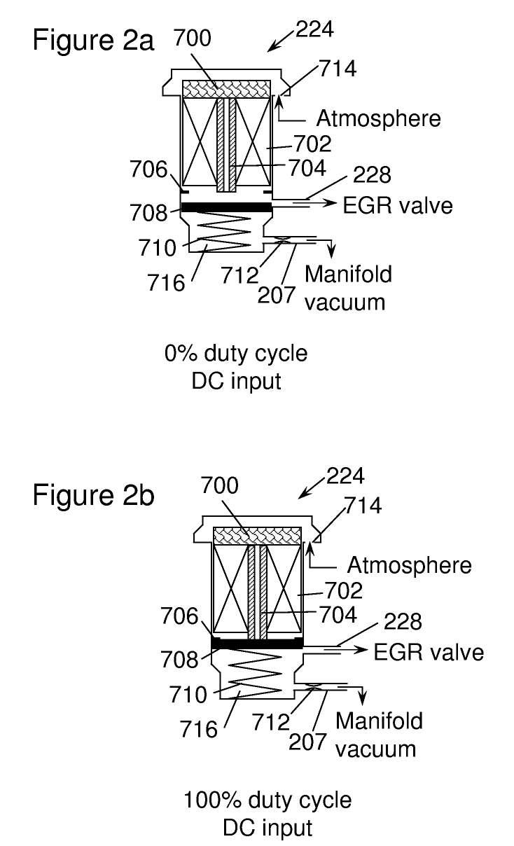

In FIGS. 2a and b, EVR 224 is shown in more detail. EVR 224 has a port 714 communicating with atmospheric air which relieves the vacuum in the EGR valve system depending on the position of disk 708. Any air inducted through port 714 passes through a mechanical filter 700 to remove debris and passes through hollow stator 704. FIG. 2a shows EVR 224 when no DC is input to coil 702. Disk 708 is in a neutral position, as determined by spring 710, because stator 704 is not applying an attractive force to disk 708. Port 228 communicating with the EGR valve communicates with atmospheric pressure.

In FIG. 2b, 100% duty cycle DC input is applied to coil 702. Stator 704 attracts disk 228. Disk 228 raises until it meets with stop 706, which is a ring that seals against disk 228. When disk 708 is sealed against stop 706, port 228 is sealed off from atmospheric pressure. Manifold vacuum is trapped within the lower portion 716 of EVR 224. That vacuum is communicated to the EGR valve through port 288. Because there is stop 706 seals disk 708 from atmospheric pressure, the vacuum in 710 that is communicated to the EGR valve is maintained for a long period of time and actuates the EGR valve to stay open. Within port 207 which connects to the intake manifold, there is a restrictor 712. In one non-limiting embodiment, the diameter of restrictor 712 is about 0.3 mm.

In the prior art, EVR 224 does not have stop 706. Without stop 706, the vacuum can be maintained briefly simply due to the tight fit of disk 708 within the EVR body. However, the desire is to maintain the vacuum for a longer period could be accomplished by using tighter tolerances in the disk 708 to EVR body interface. However, such a solution could be costly. In the present invention, stop 706 is provides a surface for disk 708 to abut to provide the desired sealing to trap the vacuum. In FIG. 2a-b, stop 706 appears in a cross-section view. Stop 706 is round to provide sealing around the circumference of disk 708.

However, to maintain the vacuum to accomplish the goal of trapping the vacuum so that the EGR valve can be maintained in an open position, the interface between disk 708 and the EVR body.

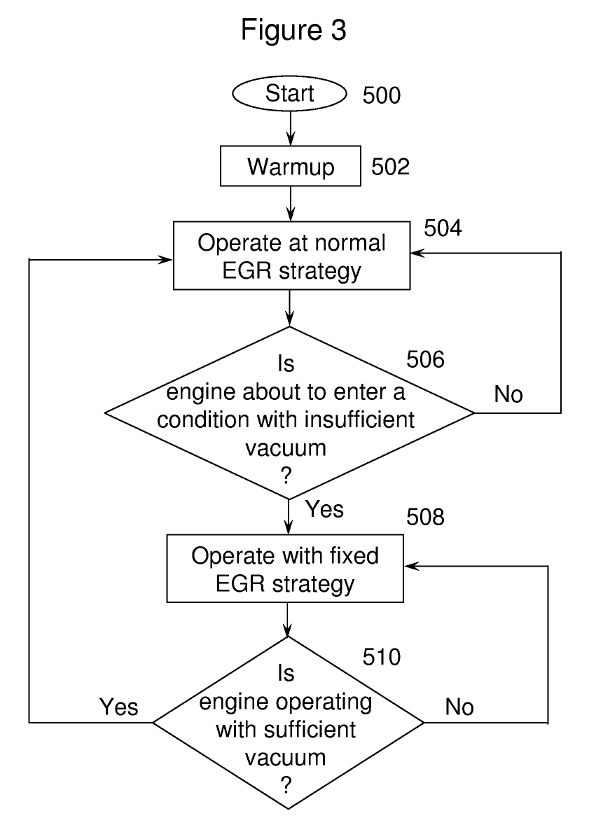

In FIG. 3, the engine is started in 500 and is warmed up in 502. After warm up, the normal EGR strategy is employed in 504. A check is performed periodically in 506. If the engine continues to operate without encountering insufficient vacuum to operate the EGR valve, control passes back to 504. When insufficient vacuum is encountered in 506, control passes to 508 in which the fixed (command to fully open) EGR strategy is employed. A check is performed periodically in 510. If the engine falls back into a condition with sufficient vacuum, control returns to 504; otherwise, control returns to 508.

A number of embodiments of the invention have been described. Nevertheless, it will be understood that various modifications may be made without departing from the spirit and scope of the invention. Accordingly, other embodiments are within the scope of the following claims.

I claim:

1. An exhaust gas recirculation (EGR) system for an internal combustion engine, comprising:
an EGR valve for controlling exhaust gas flow between an exhaust manifold of the engine and an intake manifold of the engine;
an electronic valve regulator coupled to said EGR valve and an engine intake;
a coil and stator disposed in said electronic valve regulator;
a disk within the body of said electronic valve regulator, said disk being attracted to rise and cause engine intake vacuum to be communicated to said EGR valve by said stator when a DC voltage is applied to said coil; and
a stop within said electronic valve regulator against which said disk abuts when fully actuated toward said stator.

2. The EGR system of claim 1 wherein a seal is formed between said seal and said disk.

3. The EGR system of claim 1 wherein said stop is in the shape of a ring and attaches to the internal surface of the body of said electronic valve regulator.

4. The EGR system of claim 1, further comprising: a spring coupled to said disk, said spring acting to pull said disk away from said stator.

5. The EGR system of claim 4 wherein said disk is caused to move away from said stop by action of said spring when no DC voltage is applied to said coil.

6. The EGR system of claim 4, further comprising: a controller electronically coupled to said coil.

7. The EGR system of claim 6 wherein when said controller causes a DC voltage to be applied to said coil, said disk moves toward said stator abutting said stop, said interface between said disk and said stop causes a seal to form between an upper and lower side of said disk.

8. The EGR system of claim 7 wherein when a vacuum is applied to said electronic valve regulator and said disk abuts said stop, a vacuum is communicated to said EGR valve.

9. The EGR system of claim 1, further comprising:
a first port connecting said electronic valve regulator with an engine intake;
a second port connecting said EGR valve with said electronic valve regulator wherein vacuum is communicated to actuate the EGR valve by said electronic valve regulator.

10. A method to control an exhaust gas recirculation (EGR) valve coupled between an engine intake and engine exhaust of an internal combustion engine, comprising:
providing an electronic valve regulator coupled to said EGR valve and an engine intake, said electronic valve regulator having disposed therein a coil and stator; a disk acted on by said stator; and
a stop against which said disk abuts when fully actuated toward said stator.

11. The method of claim 10, further comprising:
supplying DC current to said coil to cause said stator to pull said disk toward said stator.

12. The method of claim 11 wherein said disk, when abutted with said stop, seals between a portion of said electronic valve regulator above said disk and a portion below said disk which communicates with manifold vacuum, allowing a vacuum to be maintained on said portion below said disk.
